(19) United States
(12) Patent Application Publication
(10) Pub. No.: US 2010/0225598 A1
(43) Pub. Date: Sep. 9, 2010

(54) MULTI-TOUCH AND HANDWRITING-RECOGNITION RESISTIVE TOUCHSCREEN

(76) Inventor: Jia-You SHEN, Taichung County (TW)

Correspondence Address: Ching-Ling Huang, 5597 NW 127th Ter, Portland, OR, 97229, US

(21) Appl. No.: 12/398,192

(22) Filed: Mar. 5, 2009

(51) Int. Cl. G06F 3/041; G06K 9/00

(52) U.S. Cl. 345/173; 382/187

(57) ABSTRACT

The present invention discloses a multi-touch and handwriting-recognition resistive touchscreen, which comprises a touch layer, a spacer layer, a sensing layer and a controller. The touch layer and the sensing layer are separated by the spacer layer and respectively have a plurality of strip-like touch loops and a plurality of strip-like sensing loops. The touch layer is superimposed on the sensing layer with the touch loops oriented vertically to the sensing loops. The controller respectively connects to and supplies voltages to the two terminals of each touch loop and the two terminals of each sensing loop to enable a digital-mode driving and an analog-mode driving in different time intervals. The controller can integrate the multi-touch function and the handwriting-recognition function. Alternatively, a switch is used to switch the controller to operate in the digital mode enabling the multi-touch function or the analog mode enabling the handwriting-recognition function.

### FIELD OF THE INVENTION

The present invention relates to a touchscreen, particularly to a resistive touchscreen which has multi-touch and can detect the dragging track.

### BACKGROUND OF THE INVENTION

Refer to FIG. 1. In a digital resistive touchscreen, a spacer 1A separates two films 2A and 3A; X-direction electrode wire 4 and Y-direction electrode wire 5 are respectively arranged on the films 2A and 3A; a controller 6A connects with the ends of the X-direction electrode wire 4 and Y-direction electrode wire 5. Pressing the two films 2A and 3A to contact each other short-circuits the X-direction electrode wire 4 and Y-direction electrode wire 5, whereby the controller 6A can detect the position where the user presses the two films 2A and 3A.

Refer to FIG. 2. In a four-line analog resistive touchscreen, a spacer 1B separates two films 2B and 3B; two conductive layers 7 and 8 are respectively plated on the two films 2B and 3B; conductive contact layers 9 are arranged on the edges of the conductive layers 7 and 8, In the conductive layer 7, the opposite conductive contact layers 9 on the edges along one orientation are connected to a controller 6B. In the conductive layer 8, the opposite conductive contact layers 9 on the edges along another orientation are also connected to the controller 6B. The controller 6B supplies a voltage to one edge of the film 2B. When the user presses the two films 2B and 3B to contact each other, the controller 6B detects the partial voltages of the other three edges of the film 2B and the other three edges of the film 3B and calculates the position where the user presses.

The abovementioned digital touchscreen has the multi-touch function but cannot detect the dragging track, i.e. lacks the handwriting-recognition function. The abovementioned analog touchscreen can detect the dragging track but lacks the multi-touch function. Thus, the user cannot have both functions when using only one of the abovementioned touchscreens.

### SUMMARY OF THE INVENTION

The primary objective of the present invention is to provide a multi-touch and handwriting-recognition resistive touchscreen, which has a multi-touch function and a handwriting-recognition function.

The multi-touch and handwriting-recognition resistive touchscreen of the present invention comprises a touch layer, a spacer layer, a sensing layer and a controller. The touch layer has a plurality of strip-like touch loops. Each touch loop has a first touch terminal and a second touch terminal, and two conductive contact layers are respectively arranged at the two terminals of the touch loop. The sensing layer has a plurality of strip-like sensing loops. Each sensing loop has a first sensing terminal and a second sensing terminal, and two conductive contact layers are respectively arranged at the two terminals of the sensing loop. The spacer layer has a specified thickness to separate the touch layer and the sensing layer with the touch loops oriented vertically to the sensing loops.

The controller is respectively connected to the first touch terminals, the second touch terminals, the first sensing terminals and the second sensing terminals via the conductive contact layers. The controller is controlled by a switch to generate a digital-mode voltage or an analog-mode voltage. The controller can also alternately generate the digital-mode voltage and the analog-mode voltage continually. The digital-mode voltage is input to the first touch terminals and the first sensing terminals via the conductive contact layers, whereby the controller can detect the position where the touch loops and the sensing loops are short-circuited. The analog-mode voltage is input to the first touch terminals via the conductive contact layers, whereby the controller can detect the partial voltages of the second touch terminals, the first sensing terminals and the second sensing terminals and calculate the position where the touch loops and the sensing loops are short-circuited.

In the present invention, the controller alternately supplies the digital-mode voltage and the analog-mode voltage in a time-sharing way to drive the resistive touchscreen to operate in the digital mode and the analog mode respectively in different time intervals. Thus, the present invention uses the controller to integrate the functions of detecting multiple touches and dragging movements and realizes a multi-touch and handwriting-recognition resistive touchscreen.

### BRIEF DESCRIPTION OF THE DRAWINGS

FIG. 1 is a diagram schematically showing a conventional digital resistive touchscreen;

FIG. 2 is a diagram schematically showing a conventional analog resistive touchscreen;

FIG. 3 is a diagram schematically showing the structure of a multi-touch and handwriting-recognition resistive touchscreen according to one embodiment of the present invention;

FIG. 4 is a diagram schematically showing a controller performs a digital-mode driving according to one embodiment of the present invention;

FIG. 5 is a diagram schematically showing a controller performs an analog-mode driving according to one embodiment of the present invention; and

FIG. 6 is a diagram schematically showing the structure of a multi-touch and handwriting-recognition resistive touchscreen according to another embodiment of the present invention.

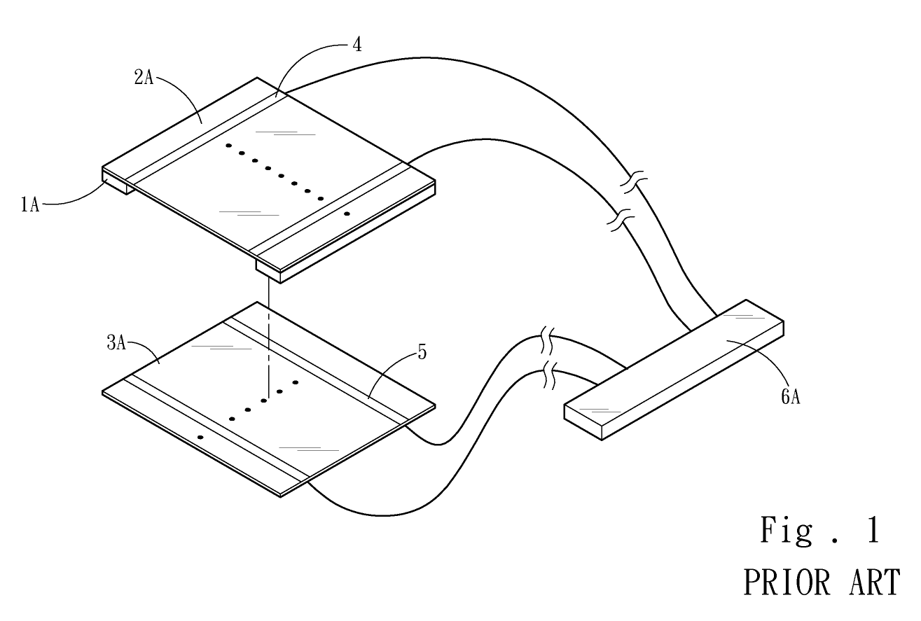

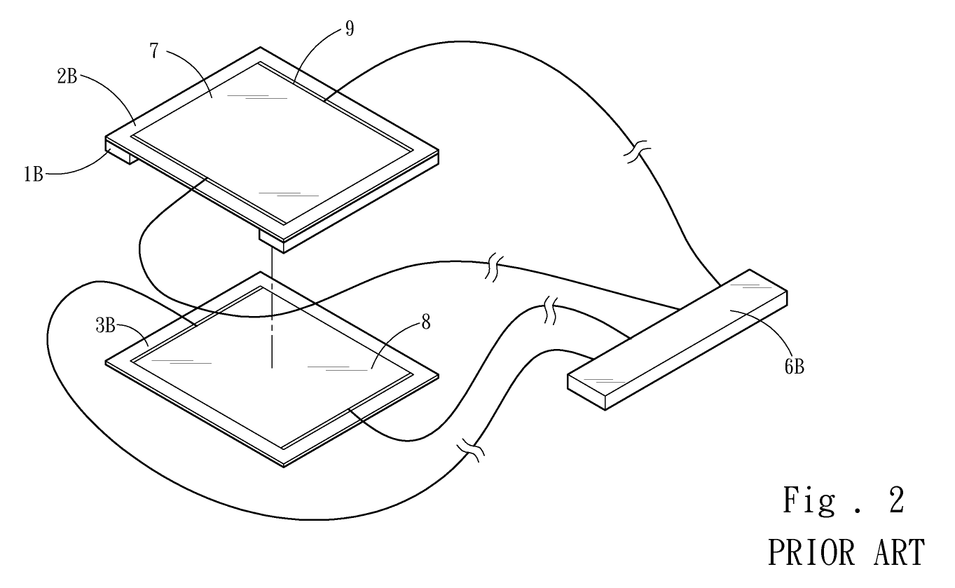

### DETAILED DESCRIPTION OF THE PREFERRED EMBODIMENTS

Below, the preferred embodiments are described in detail in cooperation with the drawings.

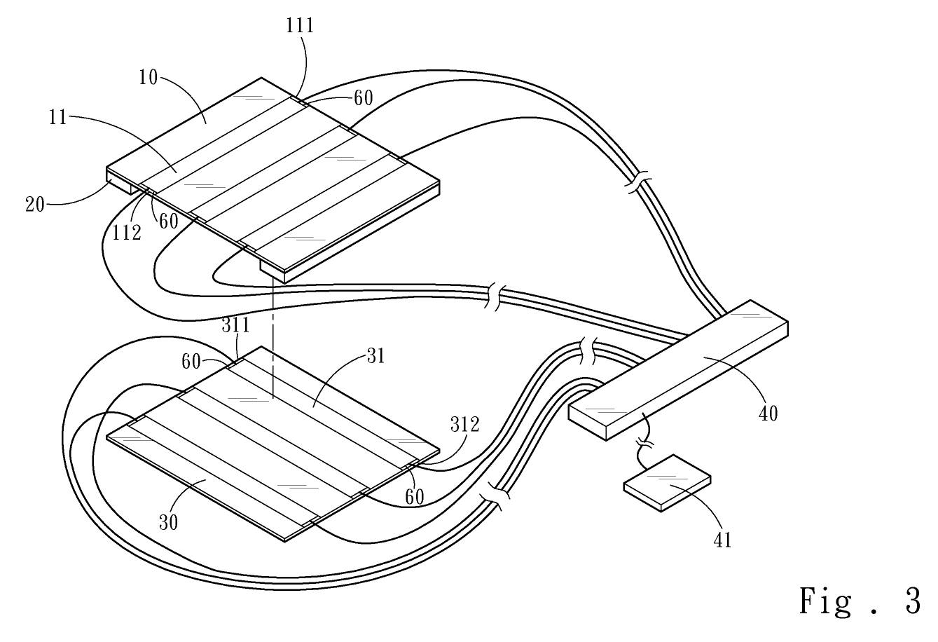

Refer to FIG. 3. The touchscreen of the present invention comprises a touch layer 10, a spacer layer 20, a sensing layer 30 and a controller 40. The touch layer 10 has a plurality of strip-like touch loops 11. The touch loop 11 has a first touch terminal 111 and a second touch terminal 112. Two conductive contact layers 60 are respectively arranged at the two terminals of the touch loop 11. The conductive contact layers 60 are made of a low-resistance material. The sensing layer 30 has a plurality of strip-like sensing loops 31. The sensing loop 31 has a first sensing terminal 311 and a second sensing terminal 312. Two conductive contact layers 60 are respectively arranged at the two terminals of the sensing loop 31. The spacer layer 20 has a specified thickness. The touch layer 10 and the sensing layer 30 are separated by the spacer layer 20 with the strip-like touch loops 11 oriented vertically to the strip-like sensing loops 31.

The controller 40 is respectively connected to the first touch terminals 111, the second touch terminals 112, the first sensing terminals 311 and the second sensing terminals 312 via the conductive contact layers 60. The controller 40 can automatically detect the driving movements in a digital mode and an analog mode. Further, the controller 40 may be connected to a switch 41, whereby the user can manually switch the controller 40 to operate in the digital mode or the analog mode. On the resistive touchscreen of the present invention, there are numerous touch loops 11 each having the first touch terminal 111 and the second touch terminal 112 and numerous sensing loops 31 each having the first sensing terminal 311 and the second sensing terminal 312. However, only three touch loops 11 and three sensing loops 31 are drawn in the drawings for exemplification.

Refer to FIG. 4. The touch layer 10 is superimposed on the sensing layer 30. When set to be in the automatic detection mode, the controller 40 alternately generates a digital-mode voltage VD1, VD2 or VD3 and an analog-mode voltage VA continually. The time of outputting the digital-mode voltage VD1, VD2 or VD3 may be controlled to be very short, for example, 0.1 sec. The time of outputting the analog-mode voltage VA may be also controlled to be very short, for example, 0.1 sec. The digital-mode voltage VD1, VD2 or VD3 is input to the first sensing terminals 311 via the conductive contact layers 60. When the touch loops 11 and the sensing loops 31 are short-circuited (the touchscreen is pressed), the voltage differences vary, whereby the controller 40 can detect the position where the short circuit occurs, i.e. the position where the touchscreen is pressed. Thus, the multi-touch function is achieved in the present invention.

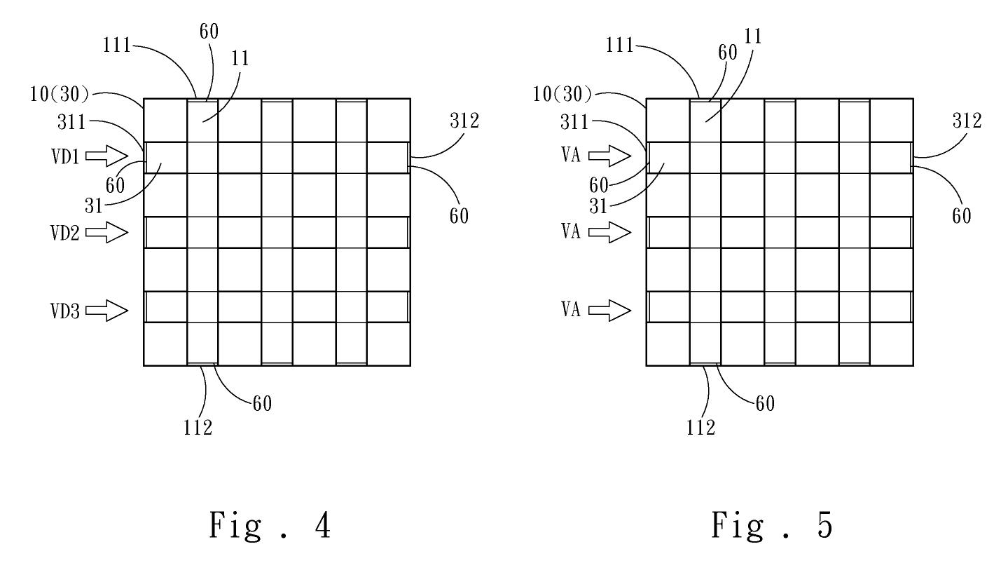

Refer to FIG. 5. When the controller 40 is in the automatic detection mode, the analog voltage VA is input to the first touch terminals 111 via the conductive contact layers 60. Herein, it should be noted that the identical analog voltage VA is input to all the first touch terminals 111 simultaneously. Thereby, a plurality of first touch terminals 111 and second touch terminals 112 and a plurality of first sensing terminals 311 and second sensing terminals 312 equivalently (equipotential) form the structure of a four-line analog resistive touchscreen. When the touch loops 11 and the sensing loops 31 are short-circuited (the touchscreen is pressed), the controller 40 can detect the partial voltages of the second touch terminals 112, the first sensing terminals 311 and the second sensing terminals 312 and calculate the position where the touch loops 11 and the sensing loops 31 are short-circuited. Thus, the controller 40 can also detect dragging movements on the resistive touchscreen.

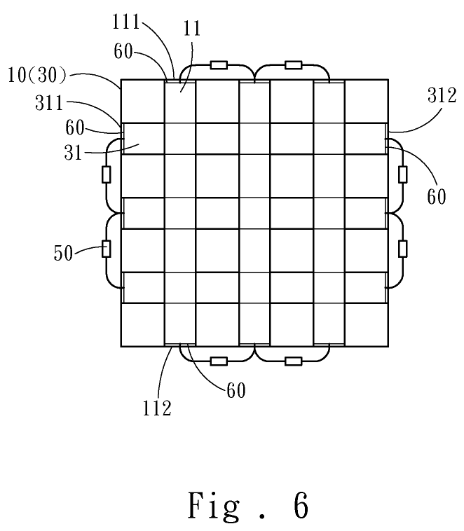

Refer to FIG. 6. The first touch terminals 111 are connected by a plurality of transistors 50; so are the second touch terminals 112, the first sensing terminals 311 and the second sensing terminals 312. The transistors 50 are connected to the controller 40. When the controller 40 generates the analog voltage VA, the controller 40 turns on the transistors 50 to enable a plurality of first touch terminals 111, second touch terminals 112, first sensing terminals 311 and second sensing terminals 312 to form the structure of a four-line analog resistive touchscreen.

Via the switch 41, the controller 40 can be manually switched to the digital mode only outputting the digital-mode voltage VD1, VD2 or VD3 or the analog mode only outputting the analog-mode voltage VA. Thereby, the resistive touchscreen can purely operate in the digital mode having the multi-touch function or the analog mode having the handwriting-recognition function.

In the present invention, the controller alternately supplies the digital-mode voltage VD1, VD2 or VD3 and the analog-mode voltage VA to drive the resistive touchscreen to operate in the digital mode and the analog mode in a time-sharing way. Thus, the present invention has the advantages of the digital resistive touchscreen and the analog resistive touchscreen and realizes a multi-touch and handwriting-recognition resistive touchscreen.

What is claimed is:

1. A multi-touch and handwriting-recognition resistive touchscreen comprising
a touch layer having a plurality of strip-like touch loops, wherein each said strip-like touch loop has a first touch terminal and a second touch terminal, and two conductive contact layers are respectively arranged at two said terminals of said touch loop;
a spacer layer having a specified thickness;
a sensing layer having a plurality of strip-like sensing loops, wherein each said strip-like sensing loop having a first sensing terminal and a second sensing terminal, and two said conductive contact layers are respectively arranged at two said terminals of said sensing loop, and wherein said touch layer and said sensing layer are separated by said spacer layer with said strip-like touch loops oriented vertically to said strip-like sensing loops; and a controller respectively connected to said first touch terminals, said second touch terminals, said first sensing terminals and said second sensing terminals via said conductive contact layers, and alternately generating a digital-mode voltage and an analog-mode voltage continually,
wherein when said digital-mode voltage is input to said first touch terminals and said first sensing terminals via said conductive contact layers and when said touch loops and said sensing loops are short-circuited, said controller detects a position where said touch loops and said sensing loops are short-circuited, and
wherein when said analog-mode voltage is input to said first touch terminals via said conductive contact layers and when said touch loops and said sensing loops are short-circuited, said controller detects partial voltages of said second touch terminals, said first sensing terminals and said second sensing terminals and calculates a position where said touch loops and said sensing loops are short-circuited.

2. The multi-touch and handwriting-recognition resistive touchscreen according to claim 1, wherein there are numerous said strip-like touch loops each having said first touch terminal and said second touch terminal, and there are numerous said strip-like sensing loops each having said first sensing terminal and said second sensing terminal.

3. The multi-touch and handwriting-recognition resistive touchscreen according to claim 2, wherein said analog-mode voltage is input to a plurality of said first touch terminals simultaneously to make a plurality of said first touch terminals, a plurality of said second touch terminals, a plurality of said first sensing terminal and a plurality of said second sensing terminals have an identical potential.

4. The multi-touch and handwriting-recognition resistive touchscreen according to claim 2, wherein a plurality of said first touch terminals are connected by a plurality of transistors; a plurality of said second touch terminals are connected by a plurality of transistors; a plurality of said first sensing terminals are connected by a plurality of transistors; and a plurality of said second sensing terminals are connected by a plurality of transistors; said transistors are connected to said controller; when said controller generates said analog-mode voltage, said controller controls said transistors to turn on.

5. The multi-touch and handwriting-recognition resistive touchscreen according to claim 1, wherein said controller has a switch whereby a user can manually switch said controller to an operation mode purely outputting said digital-mode voltage or an operation mode purely outputting said analog-mode voltage.
